(19) United States
(12) Patent Application Publication
(10) Pub. No.: US 2011/0250575 A1
(43) Pub. Date: Oct. 13, 2011

(54) System And Method For Providing A Visual Representation Of A User Personality Within A Virtual Environment

(75) Inventors: Viktor Kalvachev, Walnut Creek, CA (US); Kosta Yanev, Alamo, CA (US)

(73) Assignee: enVie Interactive LLC, Walnut Creek, CA (US)

(21) Appl. No.: 12/759,548

(22) Filed: Apr. 13, 2010

(51) Int. Cl. G09B 19/00; G06F 3/048; G06N 5/02

(52) U.S. Cl. 434/236; 715/849; 706/54

(57) ABSTRACT

A representation of a user's personality may be provided within one or more virtual environments. The personality of the user may be determined based on interactions within the one or more virtual environments. As such, the personality of the user may be determined organically without relying on declared information. A visible representation of the personality of the user may be provided to the user and/or other users within the one or more virtual environments.

### FIELD OF THE INVENTION

The invention relates to determining a personality model of a user within one or more virtual environments based on interactions of the user in the one or more virtual environment, and to presenting a visual representation of the personality model to the user and/or other users within the one or more virtual environments.

### BACKGROUND OF THE INVENTION

Systems and method for modeling personality are known. However, such systems and methods may rely wholly on responses of a subject to fill-out a survey or questionnaire with questions, and/or other declared information designed to discern the personality of the subject.

Virtual environments may monitor usage by users in order to determine demographic information about users. However, generally, determinations based on such usage are maintained in confidence by the entity that has analyzed the usage, and/or entities that have purchased the analysis or the results thereof, but are not conveyed to the users themselves and/or to other users.

### SUMMARY

One aspect of the invention relates to providing a representation of a user's personality within one or more virtual environments. The personality of the user may be determined based on interactions of the user with the one or more virtual environments. As such, the personality of the user may be determined organically without relying on declared information (e.g., received in response to surveys or questionnaires). This may provide a more accurate portrayal of the user's personality, may be less invasive to the user, may be more enjoyable to the user, and/or provide other enhancements with respect to conventional personality modeling systems in which personalities are determined primarily (if not solely) from declared information.

A visible representation of the determined personality model of the user may be provided to the user and/or other users within the one or more virtual environments. As the interaction of the user with the one or more virtual environment reflects changes to the personality model of the user, the visible representation of the personality of the user may change and/or evolve to reflect these changes. These changes may indicate that the personality of the user in the one or more virtual environments is evolving, and/or that the personality model is slowly being refined to reflect an unchanging personality over time.

In some implementations, a system configured to provide a visible representation of a personality of a user within one or more virtual environments may include one or more processors configured to execute one or more computer program modules. The one or more computer program modules may include one or more of an interaction identification module, an interaction valuation module, a personality determination module, a personality presentation module, and/or other modules.

The interaction identification module may be configured to identify interactions in one or more virtual environments that reflect a personality of the user. Such interactions may include interactions initiated by the user with the one or more virtual environments, interaction initiated by the one or more virtual environments, interaction initiated by other users through the one or more virtual environments, and/or other interactions. As used herein, “personality” may refer to a dynamic and organized set of characteristics or traits possessed by the user that influence the cognitions, motivations, and behaviors of the user in various situations. It will be appreciated that personality should not be confused with a measurement of skill, dexterity, knowledge of one or more topics, amount of participation in one or more virtual environments, or social status within one or more virtual environments.

The interactions identified by the interaction identification module may include interactions of the user with the virtual environment, interactions of the user with other users within the virtual environment, interactions of other users with the environment, interactions between other users within the virtual environment, and/or other interactions. Interactions of the user with the virtual environment and/or other users within the virtual environment may include for example, communication of the user within the virtual environment (e.g., with other users and/or the virtual environment), self-expression of the user within the virtual environment, activities of the user within the virtual environment, social connections of the user within the virtual environment, and/or other interactions. Communication of the user within the environment may include, for example, text chat, private messages, electronic mail, voice chat, forum posts, forum topics begun, forum topics read, non-player character conversations, content posts, content linked, and/or other communication within the virtual environment. Self-expression of the user within the virtual environment may include, for example, avatar customization, avatar attire and/or equipment created, purchased, and/or used, items and/or content created or modified, and/or other interactions indicating self-expression of the user within the virtual environment. Activities of the user within the virtual environment may include, for example, games participated in (or not participated in through avoidance and/or active refusal), quests or tasks accepted, quests or tasks refused or avoided, purchases, sales, trades, places visited, battles participated in and/or avoided, searches performed, and/or other activities undertaken, avoided or refueled by the user within the virtual environment. Social connections of the user within the virtual environment may include friendships accepted (e.g., within a friend management system provided in a virtual environment), friendships refused, friendship invitations extended, guilds or other associations joined, guilds or other associations refused, roles or positions held within guilds or other associations, and/or other interactions indicative of social connections of the user within the virtual environment.

The interactions identified by the interaction identification module may not be limited to interactions involving the user directly. The interactions may include interactions directed toward the user by other users. Further, the interactions identified may even include interactions between these other users that do not involve the user whose personality is being modeled. For example, the interactions may include interactions between a user that is the friend of the user whose personality is being modeled and other users, as these interactions may indicated the kind of user that is friends with the user whose personality is being modeled.

The interaction valuation module may be configured to determine impacts of the interactions identified by the interaction identification module on a determination of the user's personality. The impacts determined by the interaction valuation module may coincide with aspects of the user's personality reflected by the interactions. For example, if the user's personality is considered to be a set of characteristics or traits, a given interaction may indicate which characteristics or traits are a part of the user's personality and/or the extent to which they control the user's cognitions, motivations, and/or behaviors. As another example, if the user's personality is considered to be an amalgamation of a set of personality archetypes, a given interaction may indicate one or more personality archetypes that are a part of the user's personality and/or the extent to which the one or more personality archetypes contribute to the user's personality.

The personality determination module may be configured to determine a personality model which may represent the personality of the user. The personality determination module may determine the personality model based on interactions within the one or more virtual environments (e.g., the interactions identified by interaction identification module). The personality determination module may determine the personality model without considering responses of the user to questionnaires, surveys, and/or other declared information designed to enable discernment of the personality of the user. In some implementations, the personality determination module may determine the personality model by reflecting the impacts of interactions within the one or more virtual environments determined by the interaction valuation module into the personality model.

The personality model determined by the personality determination module may represent a set of personality traits or characteristics included in the personality of the user. The personality model determined by the personality determination module may represent a set of one or more personality archetypes present in the personality of the user.

The personality determination module may be configured such that the determination of the personality model representing the personality of the user continues to change and/or evolve in an ongoing manner. The changes and/or evolution may reflect ongoing interactions in the one or more virtual environments. In response to the user interacting with the one or more virtual environments, the interaction identification module may identify the interaction. The interaction valuation module may then determine an impact of the interaction (and/or the corresponding choice) on the personality model. The personality determination module may then adjust the personality model based on the determined impact.

The impact determined by the interaction valuation module may be determined by accessing a predefined set of values for interactions. The impact determined by the interaction valuation module may be dynamic in that it may not be determined simply by a look-up of a predetermined value, but may be determined based on the context in which it occurred (e.g., other users involved, how the other users were involved, personalities of the other users involved, time of day, time frame within the virtual environment, and/or other contextual parameters). The impact may include, for example, an increase or decrease in the presence of one or more personality traits, characteristics, and/or archetypes in the personality model.

The personality presentation module may be configured to determine a visual representation of the personality model determined by the personality determination module. The visual representation may represent the characteristics, traits, and/or archetypes present in the personality model (and/or the extent to which they are present) with color, shape, motion, relative motion, position, size, and/or other visible features. The visual representation may be presented to users in the one or more virtual environments, and/or within other virtual environments (e.g., not monitored by the interaction identification module).

In some implementations, the form of the visual representation may be selected and/or controlled by the user. For example, as was mentioned above, the user may select the type of personality model determined by the personality determination module. The selection of the type of personality model determined may select a form of visual representation (or group of potential visual representations) that corresponds to the selected type of personality model. The user may select a form of visual representations from a set of potential visual representations. The user may configure or refine certain aspects of the visual representation (e.g., color, shape, design, etc.). For instance, a set of “skins” may be available for the user to select from. One or more of the skins may be customizable by the user.

As the personality model representing the personality of the user continues to change and/or evolve (e.g., as described above), the visual representation determined by the personality presentation module may evolve in a corresponding manner.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide a representation of a user's personality within one or more virtual environments, according to one or more embodiments of the invention.

FIG. 2 illustrates a representation of the personality of a user within one or more virtual environments, in accordance with one or more embodiments of the invention.

FIG. 3 illustrates a representation of the personality of a user within one or more virtual environments, in accordance with one or more embodiments of the invention.

FIG. 4 illustrates a representation of the personality of a user within one or more virtual environments, in accordance with one or more embodiments of the invention.

FIG. 5 illustrates an evolution of a representation of the personality of a user within one or more virtual environments, in accordance with one or more embodiments of the invention.

FIG. 6 illustrates a method of providing a representation of a user's personality within one or more virtual environments, according to one or more embodiments of the invention.

### DETAILED DESCRIPTION

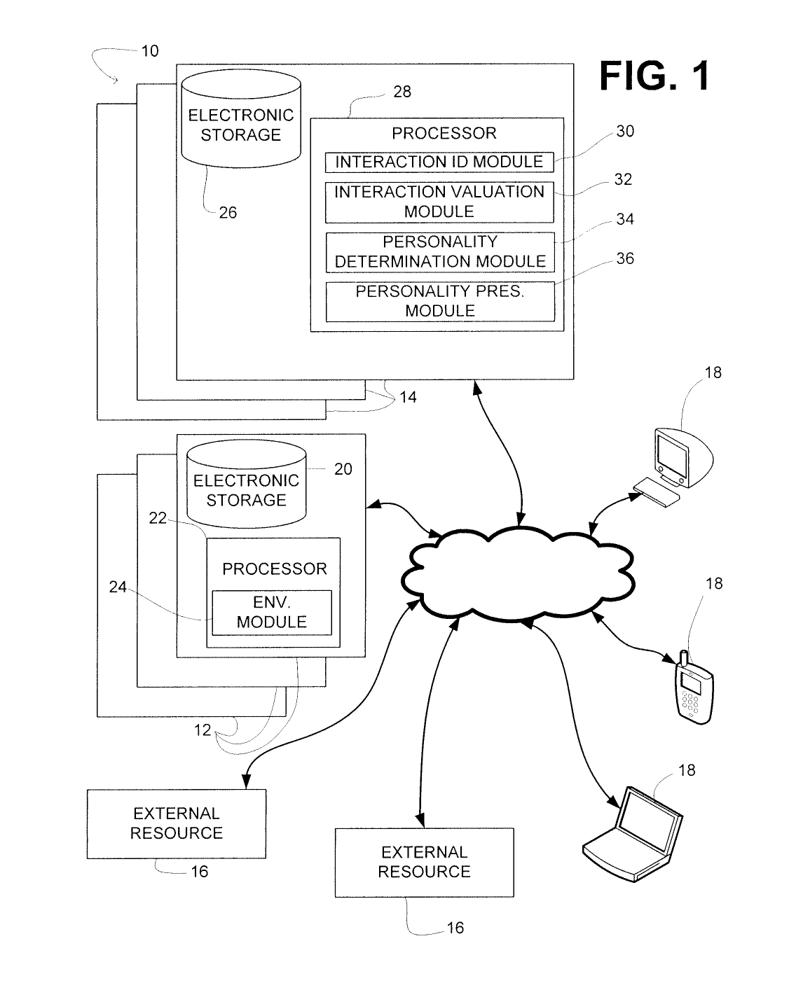

FIG. 1 illustrates a system 10 configured to provide a representation of a user's personality within one or more virtual environments. The system may determine the personality of the user based on interactions within the one or more virtual environments. As such, the personality of the user may be determined organically through choices made by the user and/or other user's in interacting with the one or more virtual environments. This may provide a more accurate portrayal of the user's personality, may be less invasive to the user, may be more enjoyable to the user, and/or provide other enhancements with respect to conventional personality modeling systems in which personalities are determined primarily (if not solely) from declared information.

The system 10 may be configured to provide a visible representation of the personality of the user to the user and/or other users within the one or more virtual environments. As the interactions within the one or more virtual environment reflect changes in the personality of the user within the one or more virtual environments, the visible representation of the personality of the user may change and/or evolve to reflect these changes.

In some implementations, system 10 may include one or more of one or more virtual environment servers 12, one or more system servers 14, and/or other components. The system 10 may operate in communication and/or coordination with one or more external resources 16. Users may interface with system 10 and/or external resources 16 via client computing platforms 18. The components of system 10, virtual environment servers 12, system servers 14, external resources 16, and/or client computing platforms 18 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which virtual environment servers 12, system servers 14, external resources 16, and/or client computing platforms 18 are operatively linked via some other communication media.

A given client computing platform 18 may include one or more processors configured to execute computer program modules. The computer program modules may be configured to enable one or more users associated with the given client computing platform 18 to interface with system 10 and/or external resources 16, and/or provide other functionality attributed herein to client computing platforms 18. By way of non-limiting example, the given client computing platform 18 may include one or more of a desktop computer, a laptop computer, a handheld computer, a NetBook, a Smartphone, and/or other computing platforms.

The external resources 16 may include sources of information, hosts and/or providers of virtual environments outside of system 10, external entities participating with system 10, and/or other resources. In some implementations, some or all of the functionality attributed herein to external resources 16 may be provided by resources included in system 10.

The virtual environment servers 12 may comprise electronic storage 20, one or more processors 22, and/or other components. The virtual environment servers 12 may include communication lines, or ports to enable the exchange of information with a network and/or other computing platforms. The processors 22 may be configured to execute computer program modules. The processors 22 may be configured to execute the computer program modules via one or more of hardware, software, and/or firmware. The computer program modules may include an environment module 24, and/or other computer program modules. Although system 10 may be described in certain sections herein as including virtual environment servers 12, this is not intended to be limiting. The virtual environment servers 12 may be separate and distinct from system 10, and may be provided by an entity that is separate from, for example, the entity providing system servers 14.

The environment module 24 may be configured to provide one or more virtual environments to users via client computing platforms 18. As used herein, a “virtual environment” may include a virtual space, one or more interactive, electronic social media, and/or other virtual environments.

A virtual space may comprise a simulated space (e.g., a physical space) instanced on a server (e.g., virtual environment servers 12) that is accessible by a client (e.g., client computing platforms 18) located remotely from the server to format a view of the virtual space for display to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.).

Within a virtual space provided by virtual environment servers 12, avatars associated with the users may be controlled by the users to interact with each other. As used herein, the term “avatar” may refer to an object (or group of objects) present in the virtual space that represents an individual user. The avatar may be controlled by the user with which it is associated. The avatars may interact with each other by physical interaction within the instanced virtual space, through text chat, through voice chat, and/or through other interactions. The avatar associated with a given user may be created and/or customized by the given user. The avatar may be associated with an “inventory” of virtual goods and/or currency that the user can use (e.g., by manipulation of the avatar and/or the items) within the virtual space.

Interactive, electronic social media may include one or more of a social network, a virtual space, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. Some non-limiting specific examples of interactive, electronic social media may include the micro-blogging service provided by Twitter™, the social network provided by Facebook™, the social network provided by MySpace™, the virtual world provided by SecondLife®, the virtual world building and hosting service provided by Metaplace®, the massively multi-player online game provided by World of Warcraft®, the file sharing service provided by Flickr®, Blogger, YouTube, PlayStation® Home, Xbox® Live, and/or other interactive electronic social media.

The system servers 14 may include electronic storage 26, one or more processors 28, and/or other components. The system servers 14 may include communication lines, or ports to enable the exchange of information with a network and/or other computing platforms. It will be appreciated that the illustration of virtual environment servers 12 and system servers 14 as two separate sets of devices is not intended to be limiting. In some implementations, virtual environment servers 12 and system servers 14 may include at least one device in common that performs some or all of the functionality attributed herein to virtual environment servers 12 and some or all of the functionality attributed herein to system servers 14.

Electronic storage 26 may comprise electronic storage media that electronically stores information. The electronic storage media of electronic storage 26 may include one or both of system storage that is provided integrally (i.e., substantially non-removable) with system servers 14 and/or removable storage that is removably connectable to system servers 14 via, for example, a port (e.g., a USB port, a firewire port, etc.) or a drive (e.g., a disk drive, etc.). Electronic storage 26 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 26 may store software algorithms, information determined by processor 28, information received from system servers 14, information received from client computing platforms 18, information received from virtual environment servers 12, and/or other information that enables system servers 14 to function properly.

Processor(s) 28 is configured to provide information processing capabilities in system servers 14. As such, processor 28 may include one or more of a digital processor, an analog processor, a digital circuit designed to process information, an analog circuit designed to process information, a state machine, and/or other mechanisms for electronically processing information. Although processor 28 is shown in FIG. 1 as a single entity, this is for illustrative purposes only. In some implementations, processor 28 may include a plurality of processing units. These processing units may be physically located within the same device, or processor 28 may represent processing functionality of a plurality of devices operating in coordination.

As is shown in FIG. 1, processor 28 may be configured to execute one or more computer program modules. The one or more computer program modules may include one or more of an interaction identification module 30, an interaction valuation module 32, a personality determination module 34, a personality presentation module 36, and/or other modules. Processor 28 may be configured to execute modules 30, 32, 34, and/or 36 by software; hardware; firmware; some combination of software, hardware, and/or firmware; and/or other mechanisms for configuring processing capabilities on processor 28.

It should be appreciated that although modules 30, 32, 34, and/or 36 are illustrated in FIG. 1 as being co-located within a single processing unit, in implementations in which processor 28 includes multiple processing units, one or more of modules 30, 32, 34, and/or 36 may be located remotely from the other modules. In implementations in which system servers 14 and virtual environment servers 12 operate in a coordinated manner to provide the functionality described herein with respect to processor 28, some or all of the functionality attributed to one or more of 30, 32, 34, and/or 36 may be provided by the modules executed on processors 22 of virtual environment servers 12. The description of the functionality provided by the different modules 30, 32, 34, and/or 36 described below is for illustrative purposes, and is not intended to be limiting, as any of modules 30, 32, 34, and/or 36 may provide more or less functionality than is described. For example, one or more of modules 30, 32, 34, and/or 36 may be eliminated, and some or all of its functionality may be provided by other ones of modules 30, 32, 34, and/or 36. As another example, processor 28 may be configured to execute one or more additional modules that may perform some or all of the functionality attributed below to one of modules 30, 32, 34, and/or 36.

The interaction identification module 30 may be configured to identify interactions within one or more virtual environments that reflect a personality of the user. As used herein, “personality” may refer to a dynamic and organized set of characteristics or traits possessed by the user that influence the cognitions, motivations, and behaviors of the user in various situations. It will be appreciated that personality should not be confused with a measurement of skill, dexterity, knowledge of one or more topics, amount of participation in one or more virtual environments, or social status within one or more virtual environments.

The interactions identified by the interaction identification module 30 may include interactions of the user with the virtual environment, interactions of the user with other users within the virtual environment, interactions of other users with the virtual environment, interactions between other users within the virtual environment, and/or other interactions. Interactions of the user with the virtual environment and/or other users within the virtual environment may include for example, communication of the user within the virtual environment (e.g., with other users and/or the virtual environment), self-expression of the user within the virtual environment, activities of the user within the virtual environment, social connections of the user within the virtual environment, and/or other interactions. Communication of the user with other users, non-player characters, administrators, and/or other entities within the virtual environment may include, for example, text chat, private messages, electronic mail, voice chat, forum posts, forum topics begun, forum topics read, non-player character conversations, content posts, content linked, and/or other communication within the virtual environment. Self-expression of the user within the virtual environment may include, for example, avatar customization, avatar attire and/or equipment created, purchased, and/or used, items and/or content created or modified, and/or other interactions indicating self-expression of the user within the virtual environment. Activities of the user within the virtual environment may include, for example, games participated in (or not participated in through avoidance and/or active refusal), quests or tasks accepted, quests or tasks refused or avoided, purchases, sales, trades, places visited, battles participated in and/or avoided, searches performed, and/or other activities undertaken, avoided or refueled by the user within the virtual environment. Social connections of the user within the virtual environment may include friendships accepted (e.g., within a friend management system provided in a virtual environment), friendships refused, friendship invitations extended, guilds or other associations joined, guilds or other associations refused, roles or positions held within guilds or other associations, and/or other interactions indicative of social connections of the user within the virtual environment.

The interactions identified by the interaction identification module 30 may not be limited to interactions involving the user directly. The interactions may include interactions directed toward the user by other users. Further, the interactions identified may even include interactions between these other users that do not involve the user whose personality is being modeled. For example, the interactions may include interactions between a user that is the friend of the user whose personality is being modeled and other users, as these interactions may indicated the kind of user that is friends with the user whose personality is being modeled.

Users may make decisions about their interactions with other users based on the personalities of the other users. For example, a first user may accept a friendship request from a second user because the second user has (or lacks) a certain personality trait, quality, or combination of traits and/or qualities reflected in her personality model. The first user may reject a friendship request from a third user because the third user lacks (or has) a certain personality trait, quality, or combination of traits and/or qualities reflected in her personality model. As the second and the third user continue to interact in the virtual environment, their interactions may continue to shape the personality model of the first user based on their relationships to the first user as having been accepted or rejected for friendship by the first user.

In some implementations, environment module 24 may be configured such that one or more entities in the virtual environment interact with the user differently based on the personality model (and/or the representation thereof). For example, a non-player character may interact with the user in a first manner if the personality model (and/or the representation thereof) indicates that the user is friendly. The non-player character may interact with the user in a second manner if the personality model indicates that the user is withdrawn, or not typically social. The differences in interaction for the non-player character may include something as subtle as using different dialogue in communicating with the user, to fighting the user or providing aid to the user based on the personality model or representation thereof) for the user. Other types of non-player character interactions that may be influenced by the personality of the user may include quests given, aid or training given, friendship accepted and/or offered, challenges made, gifts given, and/or other interactions.

The interaction valuation module 32 may be configured to determine impacts of the interactions identified by interaction identification module 30 on a determination of the user's personality. The impacts determined by interaction valuation module 32 may coincide with aspects of the user's personality reflected by the identified interactions. For example, if the user's personality is considered to be a set of characteristics or traits, a given interaction may indicate which characteristics or traits are a part of the user's personality and/or the extent to which they control the user's cognitions, motivations, and/or behaviors. As another example, if the user's personality is considered to be an amalgamation of a set of personality archetypes, a given interaction may indicate one or more personality archetypes that are a part of the user's personality and/or the extent to which the one or more personality archetypes contribute to the user's personality.

The personality determination module 34 may be configured to determine a personality model which may represent the personality of the user. The personality determination module 34 may determine the personality model based on interactions within the one or more virtual environments (e.g., the interactions identified by interaction identification module 30). The personality determination module 34 may determine the personality model without considering responses of the user to questionnaires, surveys designed to enable discernment of the personality of the user, and/or other declared information. In some implementations, personality determination module 34 may determine the personality model by reflecting the impacts of interactions by the user determined by interaction valuation module 32 into the personality model. The personality model may reflect the personality of the user within the one or more virtual environments, and/or the personality model may reflect the personality of a character under control of the user within the virtual environments (e.g., an avatar).

The personality model determined by determination module 34 may represent a set of personality traits or characteristics included in the personality of the user. For example, the personality traits or characteristics may include one or more of the personality factors described by Raymond Cattell (e.g., warmth, reasoning, emotional stability, dominance, liveliness, rule-consciousness, social boldness, sensitivity, vigilance, abstractedness, privateness, apprehension, openness to change, self-reliance, perfectionism, tension, and/or other factors) in “The description and measurement of personality”, New York: Harcourt, Brace, & Wold, 1945, which is incorporated herein by reference in its entirety. As an example, the personality traits or characteristics may include one or more of the dimensions in the five dimension personality model proposed by Lewis Goldberg (e.g., openness to experience, conscientiousness, extraversion, agreeableness, neuroticism, and/or other personality traits) in “The structure of phenotypic personality traits”, American Psychologist, vol. 48, pp. 26-34, 1993, which is incorporated by reference into this disclosure in its entirety.

The personality model determined by determination module 34 may represent a set of one or more personality archetypes present in the personality of the user. For example, the set of one or more personality archetypes may include the personality archetypes defined by the Briggs-Myers Personality Test. As an example, the set of one or more personality archetypes may include one or more personality archetypes included in the Enneagram of Personality (e.g., the Reformer, the Helper, the Achiever, the Individualist, the Investigator, the Loyalist, the Enthusiast, the Challenger, the Peacemaker, and/or other personality archetypes).

Other personality models including a set of traits, characteristics, and/or archetypes may determined by personality determination module 34. For example, personality determination module 34 may determine a personality model based on the Chakras (e.g., Crown, Third Eye, Throat, Heart, Solar Plexus, Sacral, Base, and/or other chakras). Other examples of personality models exist.

In some implementations, the type of personality model used to represent the personality of the user may be decided based on user-selection. For example, one user may select to have his personality modeled based on the Chakras, while another user may select to have his personality modeled based on the Enneagram.

The personality determination module 34 may be configured such that the determination of the personality model representing the personality of the user continues to change and/or evolve in an ongoing manner. The changes and/or evolution may reflect ongoing interaction with the one or more virtual environments by the user and/or other users. In response to the user (and/or another user(s)) making an interaction with the one or more virtual environments, interaction identification module 30 identifies the interaction. The interaction valuation module 32 may then determine an impact of the interaction on the personality model. The personality determination module 34 may then adjust the personality model based on the determined impact.

The impact determined by interaction valuation module 32 may be determined by accessing a predefined set of values for interactions. The impact determined by interaction valuation module 32 may be dynamic, in that it may not simply be determined by a look-up of a predetermined value, but may be determined based on the context in which it occurred (e.g., other users involved, how the other users were involved, time of day, time frame within the virtual environment, and/or other contextual parameters). The impact may include, for example, an increase or decrease in the presence of one or more personality traits, characteristics, and/or archetypes in the personality model.

The personality presentation module 36 may be configured to determine a visual representation of the personality model determined by personality determination module 34. The visual representation may represent the characteristics, traits, and/or archetypes present in the personality model (and/or the extent to which they are present) with color, shape, motion, relative motion, position, size, and/or other visible features. The visual representation may be presented to users (e.g., by personality presentation module 36) in the one or more virtual environments, and/or within other virtual environments (e.g., not monitored by interaction identification module 30). For example, a visual representation of a personality model determined based on interaction of the user with one or more virtual worlds may be published to another virtual environment, such as the social network of Facebook™, the social network of MySpace™, and/or other virtual environments.

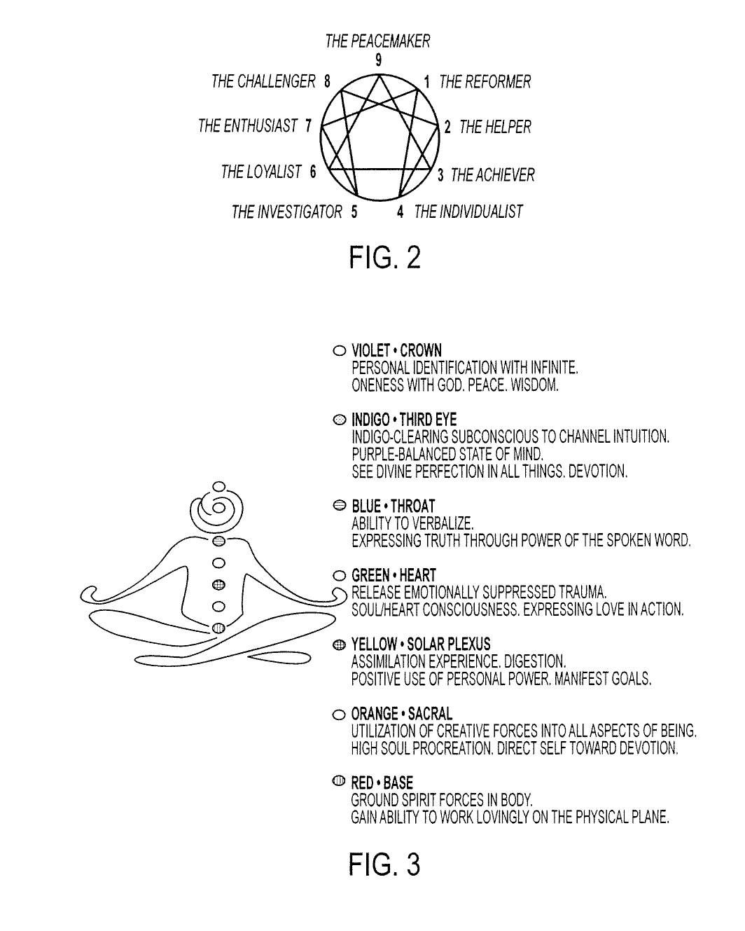

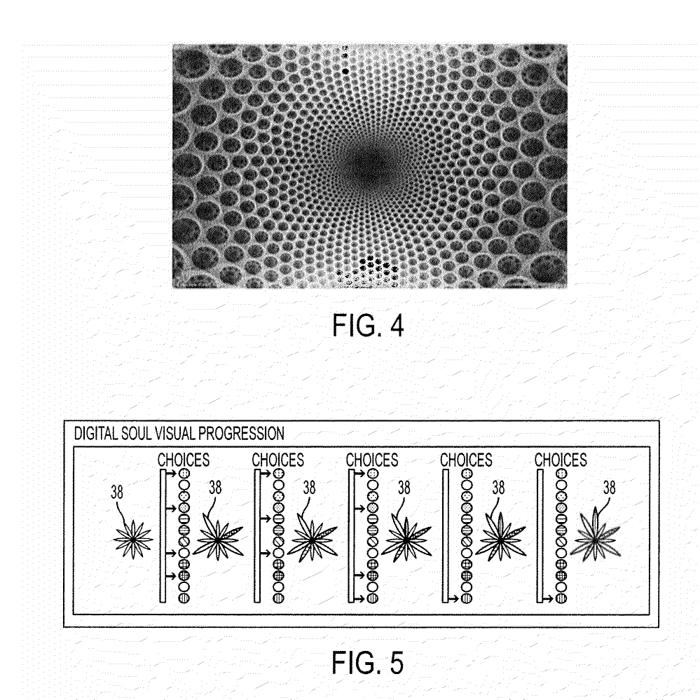

By way of illustration, FIGS. 2-4 show exemplary visual representations of personality models. As can be seen in FIGS. 2-4, the visual representation determined and/or presented by personality presentation module 36 may represent the presence and/or absence of personality traits, characteristics, and/or archetypes within the personality model corresponding to the user.

Returning to FIG. 1, in some implementations, the form of the visual representation may be selected and/or controlled by the user. For example, as was mentioned above, the user may select the type of personality model determined by personality determination module 34. The selection of the type of personality model determined may select a form of visual representation (or group of potential visual representations) that corresponds to the selected type of personality model. The user may select a form of visual representations from a set of potential visual representations. The user may configure or refine certain aspects of the visual representation (e.g., color, shape, design, etc.). For instance, a set of “skins” may be available for the user to select from. One or more of the skins may be customizable by the user.

As the personality model representing the personality of the user continues to change and/or evolve (e.g., as described above), the visual representation determined by personality presentation module 36 may evolve in a corresponding manner. For example, FIG. 5 illustrates how a visual representation 38 may continue to evolve as in accordance with ongoing choices made by the user.

Referring again to FIG. 1, it will be appreciated that the description of the determination of the personality model and the corresponding visual representation for a single user is illustrative only. In practice, system 10 may be configured to determine the personality models and corresponding visual representations for a plurality of individual users and/or groups of users.

In some implementations, the personality model determined by interaction valuation module 32 and/or the visual representation determined by personality determination module 34 may be implemented for purposes other than mere display. For example, content within a virtual environment may be tailored to the personality of the user, the user may be matched for romantic or friendship purposes based on the personality model and/or visual representation, marketing presented to the user may be tailored to the personality model and/or visual representation, and/or the personality model may be implemented for other purposes. In some implementations, the personality module and/or the representation of the personality module may provide a source of self-discovery for the user. This may enable the user to learn about his own personality, intentionally craft a certain personality and/or persona within the one or more virtual environments, and/or provide feedback to the user about what the choices that he (and/or other users) make in interacting with the one or more virtual environments indicates about his personality within the virtual environment.

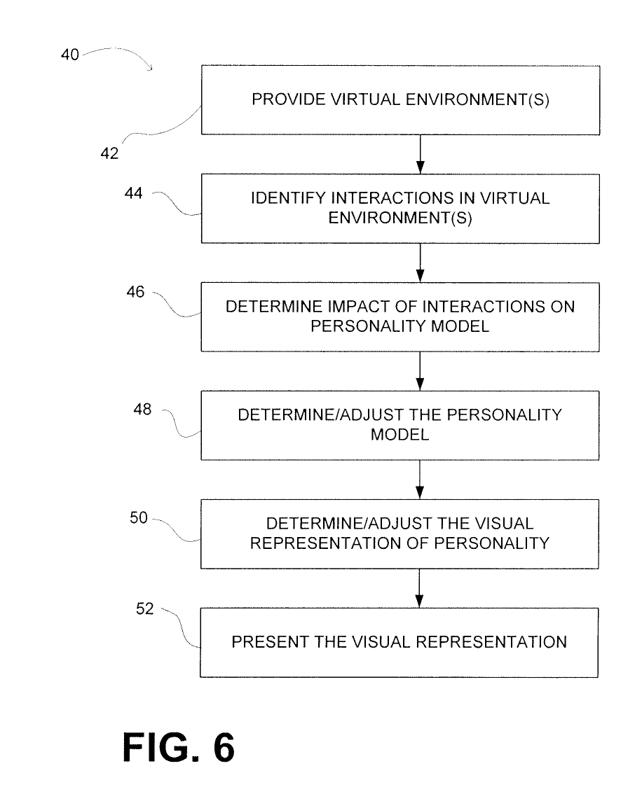

FIG. 6 illustrates a method 40 of providing a representation of a user's personality. The operations of method 40 presented below are intended to be illustrative. In some embodiments, method 40 may be accomplished with one or more additional operations not described, and/or without one or more of the operations discussed. Additionally, the order in which the operations of method 40 are illustrated in FIG. 6 and described below is not intended to be limiting.

In some embodiments, method 40 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 40 in response to instructions stored electronically on an electronic storage medium. The one or more processing devices may include one or more devices configured through hardware, firmware, and/or software to be specifically designed for execution of one or more of the operations of method 40.

At an operation 42, one or more virtual environments may be provided to the user. The one or more virtual environments may include, for example, a virtual space, an electronic, interactive social media, and/or other virtual environments. In some implementations, operation 42 may be provided by an environment module similar to or the same as environment module 24 (shown in FIG. 1 and described above).

At an operation 44, interactions in the one or more virtual environments that reflect the personality of the user within the one or more virtual environments may be identified. In some implementations, operation 44 is performed by an interaction identification module similar to or the same as interaction identification module 30 (shown in FIG. 1 and described above).

At an operation 46, impacts to a personality model of the interactions identified at operation 44 may be determined. The impacts may be determined based on predetermined impacts, and/or may be determined dynamically based on the context of the interactions. In some implementations, operation 46 is performed by an interaction valuation module similar to or the same as interaction valuation module 32 (shown in FIG. 1 and described above).

At an operation 48, a personality model representing the personality of the user may be determined. The personality model may be determined based on the interactions identified at operation 44. For example, the personality model may be determined and/or adjusted based on the impacts determined at operation 46. In some implementations, operation 48 may be performed by a personality determination module similar to or the same as personality determination module 34 (shown in FIG. 1 and described above).

At an operation 50, a visual representation of the personality model of the user may be determined. In some implementations, operation 50 may be performed by a personality presentation module similar to or the same as personality presentation module 36 (shown in FIG. 1 and described above).

At an operation 52, the visual representation may be presented to the user and/or to other users within one or more virtual environments. The one or more virtual environments may include the one or more virtual environments monitored at operation 46, and/or one or more other virtual environments (shown in FIG. 1 and described above).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to provide a representation of a user personality, wherein the system comprises:
one or more processors configured to execute computer program modules, the computer program modules comprising:
a personality determination module configured to determine a personality model that represents the personality of a user, wherein determination of the personality model is based on interactions within a first virtual environment;
a personality representation module configured to determine a visual representation of the personality model determined by the personality determination module.

2. The system of claim 1, wherein the computer program modules further comprise a personality presentation module configured to determine a visual representation of the personality model for presentation to the user and other users within the first virtual environment.

3. The system of claim 2, wherein the personality presentation module is further configured to present the visual representation of the personality model to the user and other users within a second virtual environment.

4. The system of claim 1, wherein the computer program modules further comprise an interaction identification module configured to identify interactions of the user with the first virtual environment that reflect the personality of the user within the first virtual environment, and wherein the personality determination module is configured such that the determination of the personality module is made based on the interactions identified by the interaction identification module.

5. The system of claim 4, wherein the personality determination module is configured such that the determination of the personality model is updated in an ongoing manner as the interaction identification module identifies interactions within the first virtual environment that reflect the personality or the user within the first virtual environment.

6. The system of claim 4, wherein the computer program modules further comprise an interaction valuation module configured to determine impacts, on the personality model of the user, of interactions identified by the interaction identification module, and wherein the personality determination module is configured such that the personality model is determined based on the impacts on the personality model determined by the interaction valuation module.

7. The system of claim 1, wherein the first virtual environment is a virtual world.

8. The system of claim 1, wherein the computer program modules further comprise an environment module configured to provide the first virtual environment to the user.

9. The system of claim 1, wherein personality determination module is further configured to determine the personality model further based on interactions in a second virtual environment that is different from the first virtual environment.

10. A method of providing a representation of a user personality, wherein the method is implemented in a computer system comprising one or more processors configured to execute computer program modules, and wherein the method comprises:
executing, on the one or more processors of the computer system, one or more computer program modules configured to determine a personality model that represents the personality of a user, wherein determination of the personality model is based on interactions within a first virtual environment;
executing, on the one or more processors of the computer system, one or more computer program modules configured to determine a visual representation of the personality model.

11. The method of claim 10, further comprising executing, on the one or more processors of the computer system, one or more computer program modules configured to present the visual representation of the personality model to the user and other users within the first virtual environment.

12. The method of claim 11, further comprising executing, on the one or more processors of the computer system, one or more computer program modules configured to present the visual representation of the personality model to the user and other users within a second virtual environment.

13. The method of claim 10, further comprising executing, on the one or more processors of the computer system, one or more computer program modules configured to identify interactions within the first virtual environment that reflect the personality of the user, and wherein the determination of the personality model is made based on the identified interactions.

14. The method of claim 13, wherein the determination of the personality model comprises updating the personality model in an ongoing manner as interactions within the first virtual environment that reflect the personality of the user are identified.

15. The method of claim 13, further comprising executing, on the one or more processors of the computer system, one or more computer program modules configured to determine impacts, on the personality model of the user, of the identified interactions with the first virtual environment, and wherein the determination of the personality model is made based on the determined impacts.

16. The method of claim 10, wherein the first virtual environment is a virtual world.

17. The method of claim 10, further comprising executing, on the one or more processors of the computer system, one or more computer program modules configured to provide the first virtual environment to the user.

18. The method of claim 10, further comprising executing, on the one or more processors of the computer system, one or more computer program modules configured to further determine the personality model further based on interactions within a second virtual environment that is different from the first virtual environment.
